(19) United States
(12) Patent Application Publication
(10) Pub. No.: US 2015/0114487 A1
(43) Pub. Date: Apr. 30, 2015

(54) Shut-off valve with heating element, in particular for a rail vehicle

(71) Applicant: SIEMENS AKTIENGESELLSCHAFT, Muenchen (DE)

(72) Inventor: Christian Schneider, Dinslaken (DE)

(21) Appl. No.: 14/400,042

(22) PCT Filed: Apr. 4, 2013
(86) PCT No.: PCT/EP2013/057081

§ 371 Date: Nov. 10, 2014

(30) Foreign Application Priority Data
May 16, 2012 (DE) 10 2012 208 243.3

(51) Int. Cl. F16K 49/00; B61C 17/02; B61D 35/00; B61K 11/00; F16K 5/06; F16K 31/60

(52) U.S. Cl. CPC F16K 49/002; F16K 5/0647; F16K 31/602; B61D 35/007; B61K 11/00; B61C 17/02
USPC 137/341

(57) ABSTRACT

A shut-off valve includes a housing, a shut-off element which is held in the housing and at least one cutout into which a heating element can be inserted or is inserted.

The invention relates to a shut-off valve having a shut-off element, which is mechanically retained and guided in a valve housing.

As known, there is the problem that, when shut-off valves are used in cold operating regions or in an external region, “freezing” of the shut-off valves may occur. Such freezing may, for example, occur when fluid accumulates in the region of the shut-off element and freezes as a result of an excessively low outside temperature. The consequence of freezing may be that the shut-off valve can no longer be actuated or can only be actuated with difficulty, and the line or hose system which is provided with the shut-off valve becomes unusable or at least becomes limited in terms of usability.

In the field of rail vehicle technology, freezing of shut-off valves is particularly disadvantageous since the rail vehicles can in some circumstances no longer be used when the valves are frozen, for example, since necessary maintenance operations (for example, filling with fresh water or releasing collected waste water) cannot be carried out or cannot be carried out in the planned time slots.

In order to prevent freezing of shut-off valves, a heating device is provided by the company ESBOtherm which is fitted at the outer side around the shut-off valve to be heated. The previously known heating device comprises a basket-like grid and a heating band, which is placed from the outer side around the shut-off valve.

An object of the invention is to provide a shut-off valve which is improved with respect to the above-described problem of freezing.

This object is achieved, according to the invention, by a shut-off valve having the features according to patent claim 1. Advantageous embodiments of the shut-off valve according to the invention are set out in the dependent claims.

Accordingly, there is provision, according to the invention, for the shut-off valve to have at least one recess, in which a heating element can be inserted or is inserted.

A significant advantage of the shut-off valve according to the invention can be seen in that the recess which is provided according to the invention enables a heating element to be inserted directly into the shut-off valve so that direct heat transfer from the heating element into the shut-off valve is enabled. That is to say, the heating element can be integrated completely or at least partially inside the shut-off valve, whereby the heating capacity of the heating element is advantageously produced at the location at which it is required.

Another significant advantage of the shut-off valve according to the invention can be seen in that, as a result of the integration of the heating element in the recess of the shut-off valve, inhibition of an operating device, such as, for example, an operating lever, can be reliably prevented by the heating element.

An additional significant advantage of the shut-off valve according to the invention is that it can be produced in a very compact manner owing to the integration of the heating element, and can consequently also be readily used in rail vehicles. The heating element is preferably arranged inside the shut-off valve and connected in a non-separable manner to the valve housing of the shut-off valve. Alternatively, the arrangement of the recess may also be selected in such a manner that accessibility of the heating element from the outer side—for example, for maintenance or replacement purposes—remains ensured.

The shut-off valve is preferably a ball valve having a spherical shut-off element which has a through-opening and which is rotatably retained in a ball valve housing.

In the case of a ball valve, it is considered to be particularly advantageous for the at least one recess to be located inside the ball valve and for there to be a heating element inserted into the at least one recess which is completely or at least partially surrounded by the ball valve housing.

Preferably, at least one recess is fitted at the inner housing side of the ball valve housing.

Alternatively or additionally, there may be provision for the recess or one of the recesses to form in the ball valve a blind hole which is accessible from the outer side and in which a heating element can be inserted or is inserted. The blind hole is preferably formed in the ball valve housing of the ball valve.

Alternatively or additionally, there may be provision for the recess or the recesses to form in the ball valve a through-hole which is accessible from the outer side and in which a heating element can be inserted or is inserted. Such a through-hole is preferably formed in the ball valve housing of the ball valve.

The heating element is preferably an electrical heating element in order to enable particularly simple heating.

According to another preferred embodiment, there is provision for the heating elements to be hermetically enclosed in the ball valve housing and not to be accessible from the outer side. By means of such a complete embedding in the ball valve housing, the heating elements are advantageously protected from external influences, such as corrosion, etcetera.

It is also considered to be advantageous for the heating elements to touch the spherical shut-off element of the ball valve or to be directly adjacent thereto in order to optimize the heat transfer to the spherical shut-off element.

The invention further relates to a rail vehicle having a line system for directing a fluid and having at least one shut-off valve, as described above. According to the invention, there is provision for the shut-off valve to have at least one recess in which an electrical heating element is inserted.

With regard to the advantages of the rail vehicle according to the invention, reference may be made to the above statements in relation to the shut-off valve according to the invention since the advantages of the shut-off valve according to the invention substantially correspond to those of the rail vehicle according to the invention.

According to a particularly preferred embodiment of the rail vehicle, there is provision for the shut-off valve to be arranged between a waste water collection container of the rail vehicle and a discharge connection for discharging waste water from the waste water collection container.

According to another particularly preferred embodiment of the rail vehicle, there is provision for the shut-off valve to be arranged between a fresh water collection container of the rail vehicle and a filling connection for filling the fresh water collection container with fresh water.

The invention is explained in greater detail below with reference to embodiments; in the drawings by way of example:

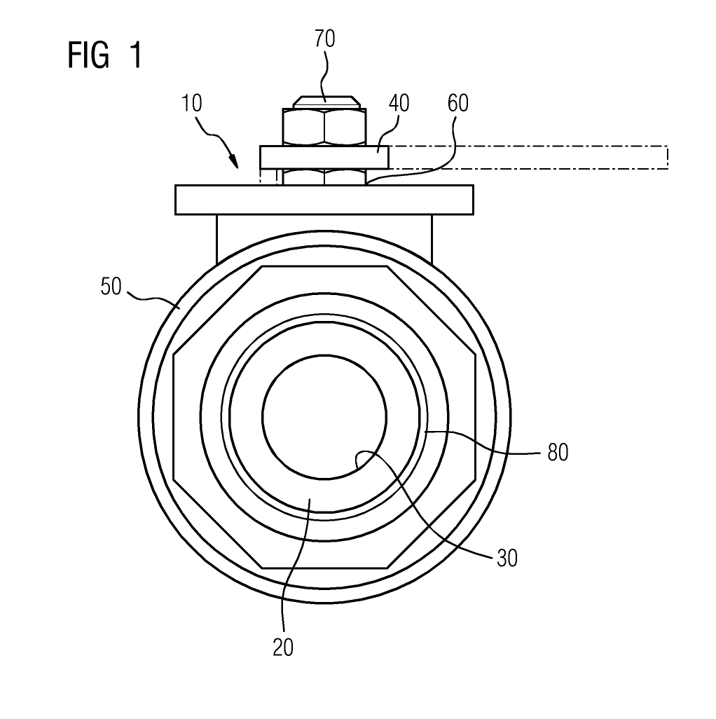

FIG. 1 shows a first embodiment of a shut-off valve according to the invention, which is a ball valve,

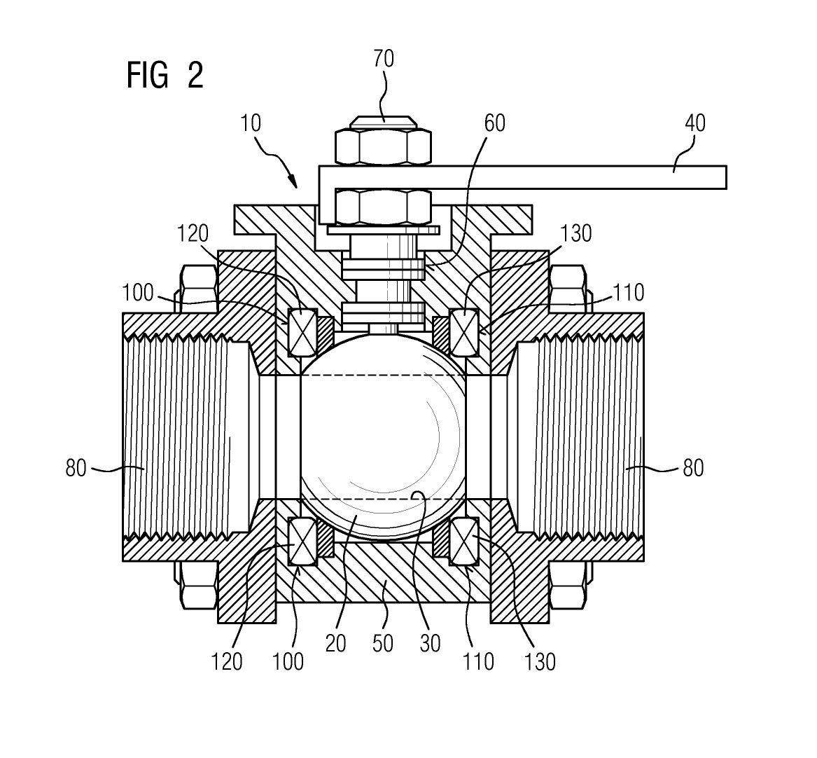

FIG. 2 is a cross-section of the ball valve according to FIG. 1,

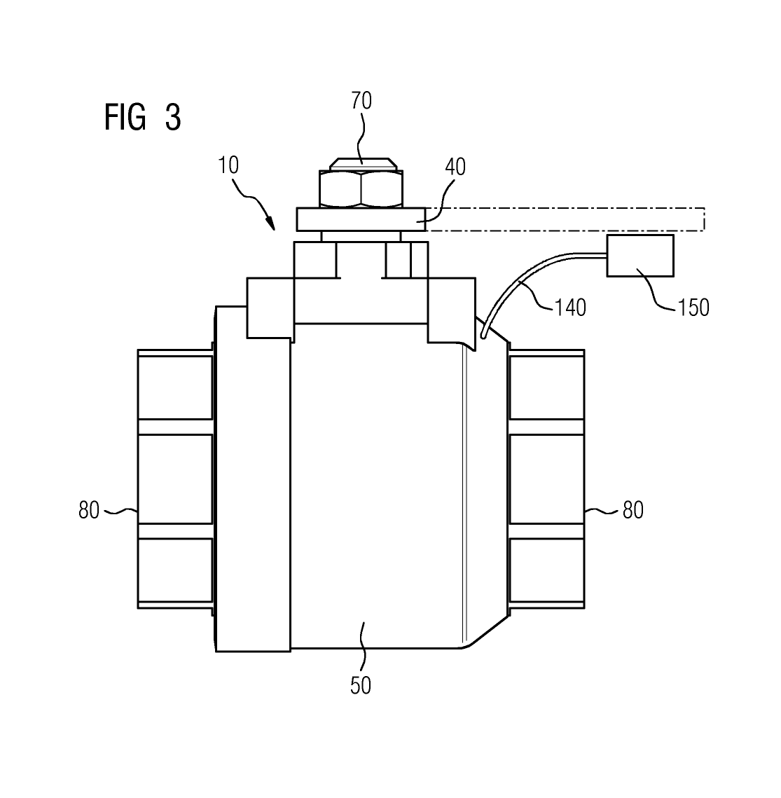

FIG. 3 is a side view of the ball valve according to FIG. 1,

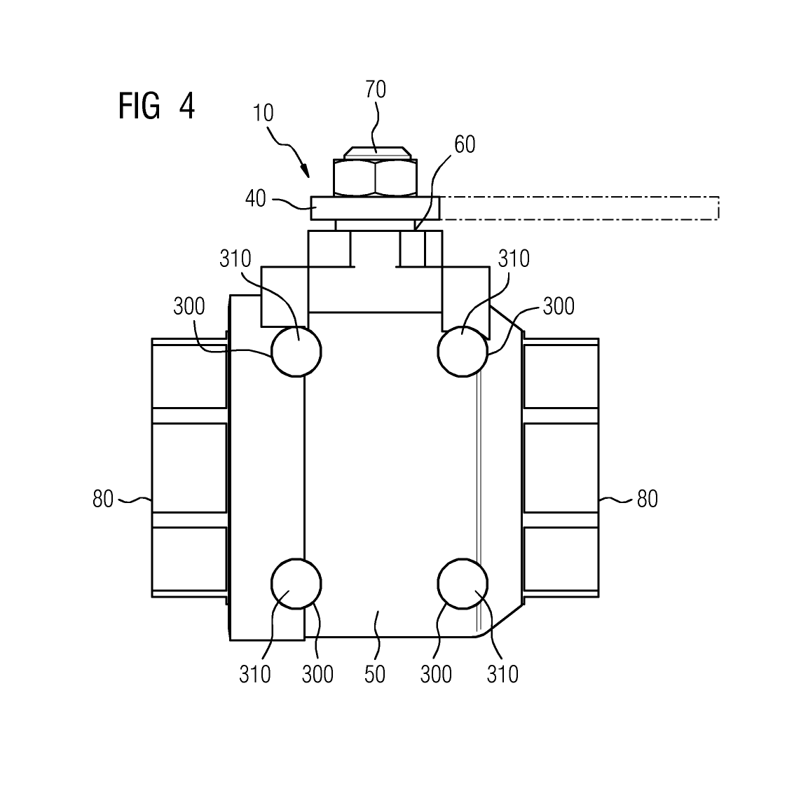

FIG. 4 shows a second embodiment of a shut-off valve according to the invention, in which holes for receiving heating elements are provided in the valve housing,

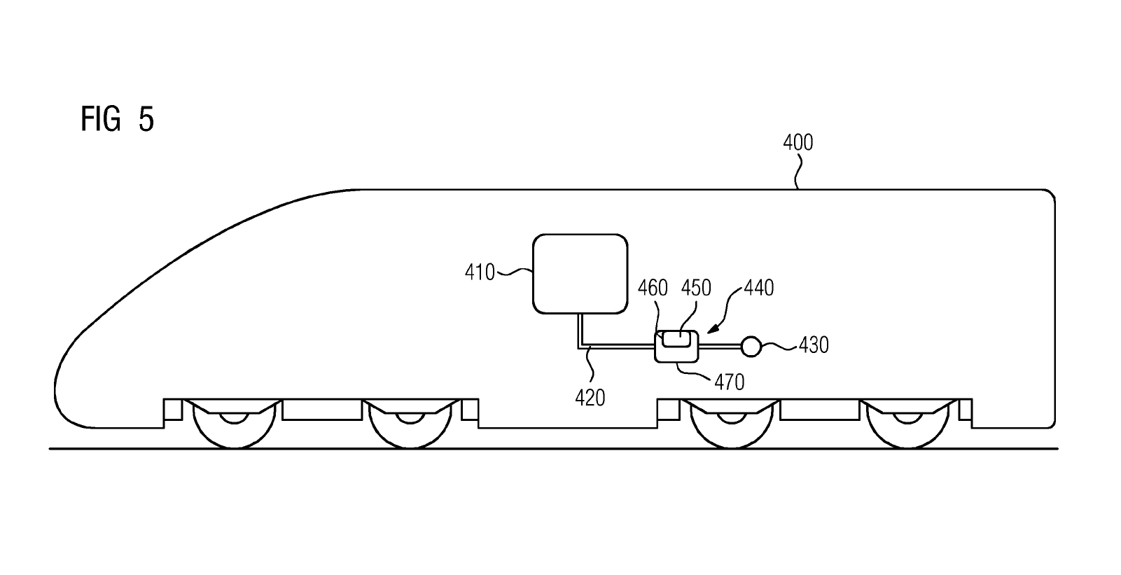

FIG. 5 shows an embodiment of a rail vehicle according to the invention having a shut-off valve, and

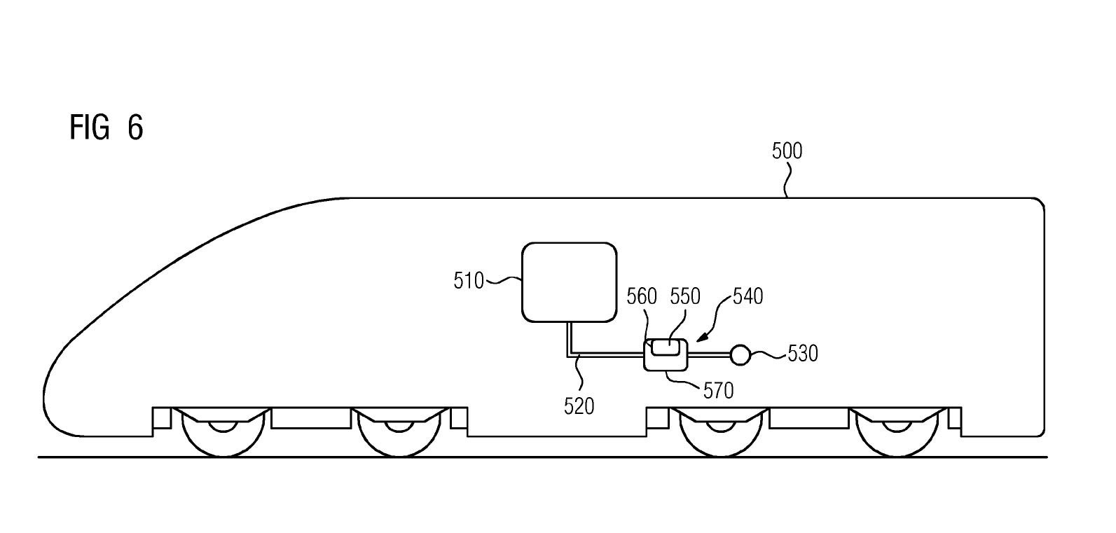

FIG. 6 shows a second embodiment of a rail vehicle according to the invention having a shut-off valve.

For the sake of clarity, the same reference numerals are always used for identical or comparable components in the Figures.

In FIG. 1, a shut-off valve can be seen in the form of a ball valve 10 which is provided with a spherical shut-off element 20. The spherical shut-off element 20 has a through-opening 30 which enables a throughflow of a fluid which is not shown in FIG. 1, that is to say, a liquid or a gas, in the position of the shut-off element 20 as shown in FIG. 1.

In FIG. 1, it is further possible to see an operating lever 40, which is mechanically connected to the spherical shut-off element 20 and which enables a pivoting or rotation of the shut-off element 20 in such a manner that the through flow of the fluid is blocked.

The spherical shut-off element 20 is retained by means of a ball valve housing 50 which has a through-opening 60. Guided through the through-opening 60 is a bolt 70 (cf. also FIG. 2) which produces a mechanical connection between the operating lever 40 and the shut-off element 20, whereby a pivotability of the shut-off element 20 is ensured when the operating lever 40 is pivoted.

The connections of the ball valve 10 for fluid lines are identified in FIG. 1 with the reference numeral 80.

FIG. 2 is a cross-section of the ball valve 10 according to FIG. 1. It is possible to see the operating lever 40, which is connected to the spherical shut-off element 20 via the bolt 70. The bolt 70 is guided through the through-opening 60.

In the ball valve housing 50, it is further possible to see two annular recesses 100 and 110 in the ball valve housing 50. The annular recesses 100 and 110 are preferably arranged at the inner housing side of the ball valve housing 50; alternatively, they may be completely mechanically integrated in the ball valve housing 50.

In the two annular recesses 100 and 110 are two annular heating elements 120 and 130 which enable heating of the ball valve housing 50 from the inner side. As a result of the arrangement of the annular heating elements 120 and 130, optimum heat transmission to the ball valve housing 50 and to the spherical shut-off element 20 is ensured so that freezing of the ball valve 10 can be prevented even at very low external temperatures.

Another advantage of the arrangement of the two annular heating elements 120 and 130 inside the ball valve housing 50 is that impairment of the operation of the operating lever 40 by the two heating elements is prevented since the operating lever 40 has no mechanical contact at all with the two heating elements.

It is considered to be advantageous when the heating elements 120 and 130 touch the spherical shut-off element 20 or are directly adjacent thereto.

FIG. 3 shows the ball valve 10 according to FIG. 1 in a view from the side. It is possible to see an electrical connection line 140 which protrudes into the ball valve housing 50 and which enables an electrical connection to the two annular heating elements 120 and 130 (cf. FIG. 2). At the line end of the electrical connection line 140 facing away from the two heating elements, there is connected an electrical connection element 150 by means of which an electrical connection to an external electrical current or voltage source is enabled.

The two annular heating elements 120 and 130 are preferably hermetically enclosed in the ball valve housing 50 and are not accessible from the outer side. As a result of such a complete embedding in the ball valve housing 50, the heating elements 120 and 130 are advantageously protected from external influences such as corrosion, etcetera.

FIG. 4 shows an embodiment of a ball valve 10, the ball valve housing 50 of which is provided with a through-opening 60 through which a bolt 70 (cf. FIG. 2) is guided. The function of the bolt 70 is to produce, inside the ball valve housing 50, a mechanical connection between an operating lever 40 and a shut-off element which is not shown in FIG. 4.

Furthermore, it is possible to see in FIG. 4 four recesses in the ball valve housing 50 which are holes in the form of blind holes 300. An electrical, preferably rod-like (for example, cylindrical), heating element 310 is inserted in each of the blind holes 300 in order to enable heating of the ball valve housing 50 and consequently the ball valve 10 as a whole from the inner side. The heating capacity of the heating elements 310 is consequently transmitted directly to the ball valve housing 50. The deeper the formation of the blind holes 300, the better the thermal efficiency of the heating elements 310 becomes.

In place of blind holes 300, it is also possible to provide as holes through-holes in which the preferably rod-like (for example, cylindrical) heating elements 310 are inserted. In the case of through-holes, the thermal efficiency of the heating elements is particularly great since the heating elements are inserted completely through the ball valve housing 50 or the ball valve 10 and can pass it.

It is considered to be advantageous for the heating elements 310 to touch the spherical shut-off element 20 or to be directly adjacent thereto.

FIG. 5 shows an embodiment of a rail vehicle 400 which is provided with a waste water collection container 410. The waste water collection container 410 is connected by means of a line system 420 to a discharge connection 430 which enables a discharge of waste water from the waste water collection container 410.

Within the line system 420 and preferably between the waste water collection container 410 and the discharge connection 430 is a shut-off valve 440 which may, for example, be one of the ball valves explained by way of example in connection with FIGS. 1 to 4. The shut-off valve 440 has a heating element 450 which is inserted in a recess 460 in the valve housing 470. The heating element 450 which is inserted into the recess 460 enables the valve housing 470 to be heated so that freezing of the shut-off valve 440 at low external temperatures can advantageously be prevented. FIG. 6 shows an embodiment of a rail vehicle 500 which is provided with a fresh water collection container 510. The fresh water collection container 510 is connected by means of a line system 520 to a filling connection 530 which enables an introduction of fresh water into the fresh water collection container 510.

Within the line system 520, and preferably between the fresh water collection container 510 and the filling connection 530 is a shut-off valve 540 which may, for example, be one of the ball valves explained by way of example in connection with FIGS. 1 to 4. The shut-off valve 540 has a heating element 550 which is inserted in a recess 560 in the valve housing 570. The heating element 550 which is inserted into the recess 560 enables the valve housing 570 to be heated so that freezing of the shut-off valve 540 at low external temperatures can advantageously be prevented.

Although the invention has been illustrated and described more specifically in detail by means of preferred embodiments, the invention is not limited by the disclosed examples and other variations can be derived therefrom by the person skilled in the art without departing from the protective scope of the invention.

1-12. (canceled)

13. A shut-off valve, comprising:
a housing;
a shut-off element retained in said housing; and
a heating element inserted or configured to be inserted in at least one recess in the shut-off valve.

14. The shut-off valve according to claim 13, wherein:
the shut-off valve is a ball valve;
said housing is a ball valve housing; and
said shut-off element is a spherical shut-off element having a through-opening and being rotatably retained in said ball valve housing.

15. The shut-off valve according to claim 14, wherein:
said at least one recess is located inside the ball valve; and
said heating element is inserted into said at least one recess and is completely or at least partially surrounded by said ball valve housing.

16. The shut-off valve according to claim 15, wherein said ball valve housing has an inside, and said at least one recess is disposed at said inside of said ball valve housing.

17. The shut-off valve according to claim 14, wherein the ball valve has an outside, said at least one recess forms a blind hole in the ball valve, and said blind hole is accessible from said outside.

18. The shut-off valve according to claim 17, wherein said blind hole is formed in said ball valve housing.

19. The shut-off valve according to claim 14, wherein the ball valve has an outside, said at least one recess forms a through-hole in the ball valve, and said through-hole is accessible from said outside.

20. The shut-off valve according to claim 19, wherein said through-hole is formed in said ball valve housing.

21. The shut-off valve according to claim 13, wherein said heating element is an electrical heating element.

22. A rail vehicle, comprising:
a line system configured to conduct a fluid; and
at least one shut-off valve according to claim 13 disposed in said line system;
said heating element of said at least one shut-off valve being an electrical heating element inserted into said at least one recess of said at least one shut-off valve.

23. The rail vehicle according to claim 22, which further comprises:
a waste water collection container; and
a discharge connection configured to discharge waste water from said waste water collection container;
said at least one shut-off valve being disposed between said waste water collection container and said discharge connection.

24. The rail vehicle according to claim 22, which further comprises:
a fresh water collection container; and
a filling connection configured to fill the fresh water collection container with fresh water;
said at least one shut-off valve being disposed between said fresh water collection container and said filling connection.
